(19) United States
(12) Patent Application Publication
(10) Pub. No.: US 2024/0294373 A1
(43) Pub. Date: Sep. 5, 2024

(54) STORAGE AND PRODUCTION OF DIHYDROGEN BY A SUSPENSION OF METAL HYDRIDE PARTICLES IN LIQUID ALKALI METAL ALLOYS

(71) Applicant: Nicolas UGOLIN, Paris (FR)

(72) Inventor: Nicolas UGOLIN, Paris (FR)

(21) Appl. No.: 18/281,071

(22) PCT Filed: Mar. 11, 2022
(86) PCT No.: PCT/FR2022/050440

§ 371 Date: Sep. 8, 2023

(30) Foreign Application Priority Data
Mar. 12, 2021 (FR) FR2102458

(51) Int. Cl. C01B 3/00

(52) U.S. Cl. CPC C01B 3/0073; C01B 3/0031

(57) ABSTRACT

The present invention relates to a system for storing dihydrogen, characterized in that it comprises a suspension of elements, in the form of hydride particles having a mean diameter of between 1 nm and 800 nm, suspended in an alloy of at least two alkali metals, chosen from Na (sodium), K (potassium) and Li (lithium). The invention also relates to a method for storing dihydrogen in a system as described above, a method for producing dihydrogen from such a system and also a device for implementing the latter method.

### TECHNICAL FIELD OF THE INVENTION

The storage and the production of the dihydrogen is a major challenge for the use of this energy carrier. In this invention, we propose a method for storing the dihydrogen in a suspension of hydrides using alkali metal alloys, known as “LAMPHY®”, and a device for producing dihydrogen from the reaction of the LAMPHY® with a jet of water projected at high speed into a cyclonic reactor.

### TECHNICAL BACKGROUND

The technical background comprises the documents US-A1-2014/072498, EP-A1-0 081 669 and the article “The Chemistry of Hydrogen in Liquid-Alkali-Metal Mixtures Useful as Nuclear Reactor Coolants—I. Sodium-Potassium Eutectic”, by Compere Edgar L. et al, Nuclear Science and Engineering, vol. 28, 0o. 3, 13 juin 1967, pages 325-337, XP055862604.

The storage and the production of dihydrogen are major energy challenges for the 21st century, since the dihydrogen represents a serious alternative to both fossil fuels and nuclear energy.

The hydrogen storage currently represents a technological barrier to the development of this energy, both for the on-line energy production, domestic and industrial electrical energy, and for the mobility energy used in the vehicles in general.

The small size of this molecule means that even though it has 4 times more energy than petrol, for the same mass it occupies 100 times more volume at atmospheric pressure. For 1 kg of dihydrogen taken at atmospheric pressure, 11 m³ of storage would be required, which poses considerable storage and transport problems.

One of the most successful methods of storing and transporting dihydrogen is to compress it in tanks. Because the dihydrogen is the smallest molecule, the walls of most tanks used to store the dihydrogen remain more or less porous, causing the stored hydrogen to volatilize through leaks of varying speed.

However, the 300-bar storage tanks offer attractive storage performance. These tanks are suitable for large vehicles and offer weak autonomy.

To increase the autonomy and therefore the amount of dihydrogen stored in the same volume, the storage pressure is tending to be increased from 300 bar to 700 bar with new-generation tanks.

But for the time being, whatever the technology used, the tanks that use the pressure to store the dihydrogen remain permeable for varying lengths of time and are therefore incompatible for the long-term storage.

Alternatives for increasing the storage time and reducing the pressure required to store the same quantity of dihydrogen include introducing carbon powders, zeolites or glass beads into the tank.

Nevertheless, the compression of dihydrogen consumes between 5 and 15% of the potential energy for the compression phase.

One of the alternatives to the compression is the liquefaction at (−252.87° c.), but this liquefaction is extremely energy-intensive, and the conservation of the liquid dihydrogen requires technologies that are still costly, both for the tanks and for the pressure-maintaining pumps.

An alternative development solution is the storage of the dihydrogen in “Liquid Organic Carrier Hydrogen”, also referred by the acronym LOCH. The hydrogen bonded to an organic molecule by a hydrogenation offers a high storage density. The storage reaction involving hydrogenation is usually exothermic. The monopolisation of the hydrogen requires this bond to be broken in order to reform the dihydrogen, usually through an endothermic reaction, which penalises the energy efficiency at the point where the dihydrogen is used.

Alternatives to the compression and to the liquefaction are being sought in the form of solid storage using metal hydrides, the most popular of which is currently the magnesium hydride MgH₂.

These hydrides come in the form of powders or agglomerates of varying sizes. The fact that hydrides are often pyrophoric powders makes their use more complex, particularly their packaging and their distribution, while ensuring that they are isolated from oxygen and from humidity.

Nevertheless, the storage in hydride form is very promising, since this chemical form is much more stable than the gaseous or liquid form, with one of the best storage capacity performances currently available at ambient temperature, in a controlled atmosphere or in mineral oils.

However, the transition from hydride to hydrogen is still problematic. None of the proposed methods is satisfactory for successful industrial applications. Several methods involve heating the hydride to release the dihydrogen. In addition to the energy consumption, which affects the efficiency, the significant changes in density between the metallic and hydride forms pose storage problems, with the fatigue of the containers during the recharge/discharge cycles.

One alternative is to use the hydride as a chemical component to produce the hydrogen on the fly by a chemical reaction between the hydride and the water, or another proton donor based on reactions already used to produce the dihydrogen on a small scale. This same type of reaction can be obtained with the metal powders such as aluminium.

The problem is that the reaction is highly exothermic and violent, and controlling the flowing of the powders requires containment gases to control the accidental ignition.

To control this reaction and its implementation more precisely, one solution consists of conditioning the hydride of the magnesium in a muddy phase, referred to as a “goop”, obtained by mixing various additives, in particular metal halides and various other additives designed to reduce the violence of the reaction.

This shape offers the advantage of an easier handling, allowing the water and the goop to be mixed using pumps or pistons. However, the behaviour of the long-term storage is not described.

On the other hand, the stabilisation of the goop leads to less reactivity of the magnesium hydride, which is more easily pacified by the hydroxide plates resulting from the reaction with water.

The storage capacity of dihydrogen by the goop is limited by a non-negligible volume of the mixture made up of various catalysts and other additives which do not intervene directly to sequester the dihydrogen.

In addition, these adjuvants comprising nanoparticles such as zirconium or other nanoparticles may be toxic to the environment and the living organisms.

Generally speaking, the additives are found in the brine resulting from the reaction of the goop with the water, which complicates the problem of recycling the brine obtained and may ultimately pose environmental problems, particularly the halogenated salt fractions resulting from the reactions.

In the context of this invention, we propose an alternative method for storing and producing dihydrogen, combined with implementing devices, which allow to offer highly responsive fluid implementation, eliminating the passivation problems, while allowing to maintain a high dihydrogen efficiency and a long storage life.

### SUMMARY OF THE INVENTION

The present invention relates to a dihydrogen storage system, characterised in that it comprises a suspension of figured elements, in the form of hydride particles with an average diameter of between 1 nm and 800 μm, suspended in an alloy of at least two alkali metals, chosen from Na (sodium), K (potassium) and Li (lithium). The hydride particles form a stable suspension in the alloy.

The system according to the invention may comprise one or more of the following characteristics, taken alone or in combination with each other:
said alloy contains at most 98% by mass of a single alkali metal, and said hydride particles have a diameter of between 50 nm and 50 μm, selected from Li H, Na H, K H, Ca H₂, Mg H₂, BeH₂, Al H₃, InH₃, TIH₃, GaH₃, BH₃, Al H₄⁻, InH₄⁻, TIH₄⁻, GaH₄⁻, BH₄⁻, TiH₂, and ZnH₂;
the proportion by mass of the alkali metal alloy with respect to the suspension of hydride particles is between 3 and 97% of the total mass of the system;
the alkali metal alloy is supplemented, up to 50% of its mass, by any combination of Be, Mg, Ca, Al, Ga, P, In and TI.

The present invention also relates to a method for storing the dihydrogen in a dihydrogen storage system as described above, characterised in that it comprises a step of preparing an alloy of at least two alkali metals, selected from Na (sodium), K (potassium) and Li (lithium), a step of preparing a plurality of hydride particles, and a step of mixing between the alloy and the particles to obtain a suspension of the particles in said alloy and the formation of said dihydrogen storage system. The hydride particles form a stable suspension in the alloy.

The method according to the invention may comprise one or more of the following characteristics or steps, taken in isolation from one another or in combination with one another:
the system comprises a suspension of figured elements (i.e. hydride particles), in the form of hydride particles with an average diameter of between 1 nm and 800 μm, suspended in an alloy of at least two alkali metals, selected from Na (sodium), K (potassium) and Li (lithium);
said alloy contains at most 98% by mass of a single alkali metal, and said hydride particles have a diameter of between 50 nm and 50 μm, selected from Li H, Na H, K H, Ca H₂, Mg H₂, BeH₂, Al H₃, InH₃, TIH₃, GaH₃, BH₃, Al H₄⁻, InH₄⁻, TIH₄⁻, GaH₄⁻, BH₄⁻, TiH₂, and ZnH₂;
the proportion by mass of the alkali metal alloy with respect to the suspension of hydride particles is between 3 and 97% of the total mass of the system;
the alkali metal alloy is supplemented, up to 50% of its mass, by any combination of Be, Mg, Ca, Al, Ga, P, In and TI.

The present invention also relates to a method for producing dihydrogen from a dihydrogen storage system, said dihydrogen storage system comprising a suspension of elements, in the form of hydride particles with an average diameter of between 1 nm and 800 μm, suspended in an alloy of at least two alkali metals, chosen from Na (sodium), K (potassium) and Li (lithium), the method comprising a step of reacting the dihydrogen storage system with H₂O.

In this application, the term “figured elements” refers to elements dispersed and suspended homogeneously in a liquid to form a suspension (or stable suspension or colloidal suspension). A suspension (or stable suspension or colloidal suspension) is a stable, homogeneous dispersion of a solid in a liquid—as opposed, for example, to a mud or a slurry in which particles are precipitated. The suspension is therefore stable and homogeneous, meaning that the particles are evenly distributed in the alloy and do not precipitate over time.

The method according to the invention may comprise one or more of the following characteristics or steps, taken in isolation from one another or in combination with one another:
the LAMPHY is in the form of a filament and is pulverized by a water jet at high speed, possibly between 0.5 m/s and 800 m/s;
the LAMPHY in filament form is produced by an extrusion simultaneously with the reaction with the water or prior to this reaction;
the method comprises a step of activating the reaction between the LAMPHY and the water using an acid, preferably the carbonic acid CO₂, optionally in one of its hydrogen carbonate and di-hydrogen carbonate forms;
the method comprises a step in which the reaction of a metal hydroxide with the CO₂ produced by an internal combustion engine, a boiler or a burner allows said CO₂ produced to be sequestered in another hydrogen carbonate or carbonate form;
the inhibition of the reaction between the LAMPHY and the water is lifted by a surface capable of altering a hydroxide callus formed on the surface of hydride particles, when a LAMPHY/water reaction mixture is projected onto said surface, said surface being for example an abrasive surface chosen from the surfaces covered with nanodiamonds, zirconia particles, carbide particles, a surface comprising an array of staggered pillars, a surface comprising an array of roofless capillaries, and any combination of these surfaces;
said alloy contains at most 98% by mass of a single alkali metal, and said hydride particles have a diameter of between 50 nm and 50 μm, selected from Li H, Na H, K H, Ca H₂, Mg H₂, BeH₂, Al H₃, InH₃, TIH₃, GaH₃, BH₃, Al H₄⁻, InH₄⁻, TIH₄⁻, GaH₄⁻, BH₄⁻, TiH₂, and ZnH₂;
the proportion by mass of the alkali metal alloy with respect to the suspension of hydride particles is between 3 and 97% of the total mass of the system;
the alkali metal alloy is supplemented, up to 50% of its mass, by any combination of Be, Mg, Ca, Al, Ga, P, In and TI.

Lastly, the present invention relates to a device for implementing a method as described above, characterised in that it comprises a cyclone-type reactor for the reaction between H₂O and the LAMPHY, this reactor comprising at least one cyclonic structure which allows the formation of a vortex, and a column of gas and vapour rising to the centre of the reactor, and having in the low position a device for extracting the heaviest solid and liquid materials, and in the top part a central collector for the vapours and gases.

The device according to the invention may comprise one or more of the following characteristics or steps, taken in isolation from each other or in combination with each other:
said extraction device comprises any combination of an endless screw, a central hub mill, a hollow endless screw, alternatively any combination of a tube and vanes which are optionally hollow;
the LAMPHY filament is produced by a device comprising a tubular container equipped at one of its ends with a piston activated by the action of a pressure of a gas and at the other end with a valve opened by the pressure transmitted by the piston, and comprising an endless screw;
a turbine containing a wheel is arranged in the cyclonic reactor, the axis of the turbine being an axis passing through the reactor to the centre of a collector, this axis being the support for the wheel of the turbine and for a set of vanes arranged on the axis at the level of the collector, and the wheel comprising two sets of vanes, a first set of inner vanes supported by the axis and by a cylinder contiguous with the collector, and a second set of vanes outside the contiguous cylinder, and at least one tangential inlet to the turbine, but preferably a plurality of inlets, and a plurality of tuyeres at the outlet of the turbine;
the cyclone-type reactor comprises in its wall an exchanger comprising a system of interconnected pipes, and suitable for circulating a heat transfer fluid selected, without being exhaustive, from the liquid alkali metal alloys comprising Li, Na, K, perfluorocarbon-based fluids, distilled water, existing heat transfer fluid, and such that, in a preferred implementation, the system of pipes of the exchanger of the cyclone is in contact with a second exchanger of an ORC (Organic Rankine Cycle) circuit;
the device further comprises a hydrogen fuel cell, a bubbling tank and a nozzle, and the dihydrogen produced by the cyclone-type reactor feeds the hydrogen fuel cell, the water produced by the consumption of dihydrogen by the hydrogen fuel cell feeds the bubbling tank, and the bubbling tank feeds the nozzle.

### BRIEF DESCRIPTION OF THE FIGURES

Further characteristics and advantages of the invention will become apparent from the following detailed description, for the understanding of which reference is made to the attached drawings in which:

FIG. 1 shows an experimental mounting for testing the efficiency of different LAMPHY compositions,

FIG. 2 shows a device for abrading/pulverization a LAMPHY filament, I) preconstituted filament, II) amorphous LAMPHY shaped into a filament by the nozzle 13,

FIG. 3 shows an abrasion device I) set up after the pulverization of the LAMPHY filament, II) particle surface, III) pillar surface, IV) labyrinth surface 20,

FIG. 4 shows a cyclonic reactor for the reaction of the LAMPHY with a proton donor, I) longitudinal cross-section, II) cross section,

FIG. 5 shows an injection of acid (CO2) into the cyclone reactor for the reaction of the LAMPHY with a proton donor, I) injection point, II) injection into the bubbler,

FIG. 6 shows I) a two-stage reaction device: a stage for reacting the LAMPHY, and a stage for reacting the CO2 with the hydroxides resulting from the reaction of the LAMPHY and the water, II) a cross-sectional view of the extraction device. III) bottom view of the extraction device,

FIG. 7 shows I) a device for feeding LAMPHY from an amorphous LAMPHY to the forming nozzle for forming the filament, II) a support grid for the endless screw, III) a sealing plug transmitting the pressure to the LAMPHY contained in the device,

FIG. 8 shows a coupling of a hydrogen fuel cell and a heat engine to the reaction device of the LAMPHY,

FIG. 9 shows an I) insertion of a turbine into the lower cyclone of the reaction device of the LAMPHY, II) cross-sectional view of the connection between the turbine and the central collection tube of the gases of the cyclone, III) outlet tuyere of the turbine, IV) inlet of the turbine organised into vanes allowing a vortex to be formed by the passage between the blades formed by the vanes,

FIG. 10 shows a coupling of a reaction device of the LAMPHY cooled with an ORC circuit,

FIG. 11 shows an alternative extraction device coupled with the central gas collection tube of the cyclone, I) without passage between the two cyclones and gas recovery, II) with passage of gases between the cyclones, V) without passage of gases between the two cyclones and without recovery of gases outside the lower cyclone, and

FIG. 12 shows a device for opening and closing the inlet valve of the LAMPHY of the device FIG. 7, I) valve closed, II) valve open.

### DETAILED DESCRIPTION OF THE INVENTION

1) The method consists in using an alloy of at least two alkali metals chosen from Na (sodium), K (potassium) and Li (lithium), such that the alloy comprises at most 98% by mass of the same alkali metal. The alloy obtained from at least two alkali metals has the particularity of being liquid in a temperature range around the ambient temperature of between −10 and 70° C., but which can be increased to between −20° C. and 800° C. depending on the composition of the alloy in question.

For example, an alloy with 78% K and 22% Na will remain liquid between −12° C. and 750° C.

For example, for such a mixture, the dynamic viscosity is given by

μ=−3.759×10−12×t³+6.3008×10−9×t²−3.729×10−6×t+9.9806×10−4 kg m⁻¹s⁻¹
with t in ° C.

The alloys obtained will have viscosity properties that can be adapted according to the proportions of the metals, ranging from a liquid with a viscosity close to that of the mercury, to a paste that can be structured into filaments, and from a liquid with a behaviour close to that of a Newtonian liquid to a paste with a non-Newtonian behaviour.

The alkali metal alloy is used to make a suspension of figured elements comprising metal hydrides in particulate form with a diameter of between 1 nm and 800 μm, preferably between 50 nm and 50 μm.

The metal hydrides will be selected without being exhaustive from the following hydrides: Li H, Na H, K H, Ca H₂, Mg H₂, BeH₂, Al H³, InH₃; TIH₃, GaH₃, BH₃, Al H₄⁻, InH₄⁻; TIH₄⁻, GaH₄⁻, BH₄⁻.

The proportion of metal alloy in the suspension can vary from 3% to 97%, with a proportion of hydrides varying from 97 to 3%. The proportions can go as far as making the mixture solid so that the mixture can be shaped into filaments so that they can be stored in spools of yarn.

This solid or highly viscous paste state, allowing the filament structuring, is obtained either by increasing the viscosity of the alkaline metal alloy by varying its composition to make it viscous, or by increasing the proportion of the nanoparticles in a low-viscosity alloy, or by any combination of these two means.

The anionic hydrides such as dH₄⁻ taken from ALH₄⁻, BH₄⁻ etc. with, d representing AL, B, Ga, In, TI may be added to the suspension with any m2+ cation such as Ca²⁺, Mg²⁺, Be²⁺ or n+ such as Na⁺, K⁺, Li⁺ in the form m d₂H₈ or n dH₄.

In general, all the pyrophosphoric metal hydrides can be used as hydride sources, comprising depleted uranium.

The non-pyrophosphoric hydrides such as the hydride of titanium TiH₂ or of zinc ZnH₂ can be used. These hydrides are stable in contact with air and water, and react very slowly. To be decomposed, these hydrides need to be activated, for example by heating them. The exothermic energy released by the constituent elements of the alkali metal alloy, and/or any other hydrides present in the suspension, when the suspension reacts with water, allows to activate these non-pyrophosphoric hydrides to decompose and react in turn with water.

In some embodiments, each illustrated element may comprise a hydride of the same nature or any combination of hydrides of different natures,

In other embodiments, the figurative elements comprise a plurality of different figurative elements wherein each figurative element comprises a hydride of the same nature.

In some embodiments, the metal alloys may be supplemented up to 50% of their mass by one or any combination of alkaline earth metals such as Be, Mg, Ca, metals such as B, Al, Ga, In, TI or phosphorus such as P, preferably black phosphorus, red phosphorus or white phosphorus or any other phosphorus phase or other elements in these categories. Certain metals such as Cu, Fe and Zn can be added to the alkali metal alloy in a minority form. Among other things, these metals allow the formation of induced hydrides such as CuH, FeH₂ and ZnH₂. The same applies to phosphorus, which could allow to produce PH₃ hydrides in the alloy.
2) The metal alloy can be obtained by melting the metals and other elements of which it is composed in a neutral atmosphere (argon) obtained in a crucible or in a solenoid by induction in a state of magnetic levitation.

The alloys can be obtained by mechanical mixing under argon, for example by lamination, which causes a mechanical mixing of the metals and other elements to obtain said alloys.

The viscosity of the alloys can be adjusted by adding Gallium in a proportion varying from 0.005% to 10% of the final mass of the alloy.

To facilitate the mixing to form the metal alloy, amalgams with Gallium can be produced, in particular for the use of non-alkaline and non-alkaline-earth metals.
3) The hydride particles can be obtained by milling the metal in a dihydrogen atmosphere at a temperature of between 50° C. and 1000° C. All types of mills can be used for milling, in particular beads mills, hammer and blade mills.

The hydrides can be obtained by rolling or extrusion in a dihydrogen atmosphere.

The hydride particles can also be obtained by pulverization a spray of molten metal in a cold dihydrogen atmosphere, or by projecting metal into a hydrogen plasma.

The hydride particles can be obtained by causing “n” to act, selected from (Li, Na, K) and “d” to act, selected from (Mg, Ca, Be) or “E” to act, selected from (Al, B, Ga, In, TI)
such that:

2n+d+H₂→dH₂+2n

6n+2E+3H₂→2EH₃+6n

8n+2E+4H₂→2nEH₄+6n

8n+2E+4H₂+d→dE₂H₈+8n
“n” acting as a catalyst.
4) the suspension of hydride particles in a liquid, even highly viscous, metal alloy, referred to herein as LAMPHY, can be obtained by simply mixing a mass proportion X % of liquid alloy and a proportion Y % of hydride particles of the same or different nature so that X+Y is equal to 100%, without counting possible additions of other elements.
5) The dihydrogen will be produced by reacting LAMPHY with a proton donor, preferably H₂O, in a reactor allowing to control the reaction.

The efficiency of the dihydrogen production will depend on the composition of LAMPHY.

The metallic alloys of composition type “n” taken from (Li, Na, K) will produce dihydrogen according to the reaction:

n+H₂O→nOH+½H₂

The metal hydrides of the nH type, “n” chosen from (Li, Na, K) will produce dihydrogen according to the reaction

nH+H₂O→nOH+H₂

The metal hydrides of the dH2 type, “d” selected from (Mg, Ca, Be)

dH₂+2H₂O→d(OH)₂+2H₂

The metal hydrides of type EH₃, “E” chosen from (AL, B, Ga, P)

EH₃+3H₂O→E(OH)₃+3H₂

The metal hydrides of the nEH₄ type, where “E” is selected from (AL, B, Ga, etc.) and “n” is selected from (Li, Na, K)

nEH₄+4H₂O→E(OH)₃+4H₂+nOH

The metal hydrides of the dE₂H₈ type, “E” selected from (AL, B, Ga etc.) “d” selected from (Mg, Ca, Be)

dE₂H₈+8H₂O→2E(OH)₃+8H₂+d(OH)₂

Because of the electronegativities of the different elements K(0.82)<Na (0.93)<Li (0.98)<Be<Ca (1)<Mg(1.31)<Be (1.57)<TI(1.62)<In(1.78)<Ga(1.81)<AL(1.61)<B(2.04)<P(2.19)

Readjustment reactions between the hydrides themselves and the hydrides and the elements of the alloy composition may eventually take place and modify the nature of the hydrides without changing the hydride load (H⁻) of the LAMPHY
such as, but not limited to:
a>b in terms of electronegativity, such that “a” and “b” are chosen from (K, Na, Li,).
“v” being selected from Mg, B, AL, Ga, P

av(H)ⱼ+bH→bv(H)j+aH,

av(H)ⱼ+b→bv(H)ⱼ+a,

and

a(H)ⱼ+jb→jb(H)+a
with “j” between (1 and 10)
6) The reactions involved are theoretically total and the efficiencies obtained represent the sum of the cumulative efficiencies of the reactions with the water of each element or ion making up LAMPHY.

However, for reasons:
passivation phenomena which can cover the particles with layers of hydroxide of the type X(OH); with j between 1 and 10, such that X can belong to the groups n, d, E, P defined above, and
hydroxide-covered particles, which can be produced during the reaction of the metal alloy of the LAMPHY with the water, can still reduce the efficiency through incomplete reactions.

One remedy for making the reactions complete and obtaining the expected efficiencies is to acidify the pH of the water used for the reaction and add a mechanical action to remove the layers (calluses) of hydroxide that protect the LAMPHY elements from the water, particularly the hydrides, preventing them from reacting with the water.
7) As an example of embodiment, different LAMPHY formulas are tested, the results of which are shown in Table 1

TABLE 1
different compositions of LAMPHY tested: compositions mg
of the elements for 1 g of LAMPHY. Last line of the table:
quantity of Dihydrogen obtained in mg/g of LAMPHY.

| | mg | mg | mg | mg |
|---|---|---|---|---|
| elements | LAMPHY | LAMPHY | LAMPHY | LAMPHY |
| Na | 110 | 110 | 110 | 110 |
| K | 390 | 390 | 390 | 390 |
| NaALH4 | | 500 | | |
| LiAlH4 | | | | 500 |
| MgH2 | 500 | | | |
| MgAl2H8 | | | 500 | |
| NaBH4 | | | | |
| LiBH4 | | | | |
| MgB2H8 | | | | |
| mg H2/g LAMPHY | 90.8 | 88.0 | 107.4 | 120.3 |
| Na | 110 | 110 | 110 | 166.5 |
| K | 390 | 390 | 390 | 166.5 |
| NaALH4 | | | | 500.5 |
| LiAlH4 | | | | |
| MgH2 | | | | |
| MgAl2H8 | | | | |
| NaBH4 | 500 | | | |
| LiBH4 | | 500 | | |
| MgB2H8 | | | 500 | |
| mg H2/g LAMPHY | 120.6 | 198.2 | 163.0 | 109.0 |
| Na | 166.5 | 166.5 | 166.5 | 166.5 |
| K | 166.5 | 166.5 | 166.5 | 166.5 |
| NaALH4 | | | | |
| LiAlH4 | | 500.5 | | |
| MgH2 | 500.5 | | | |
| MgAl2H8 | | | 500.5 | |
| NaBH4 | | | | 500.5 |
| LiBH4 | | | | |
| MgB2H8 | | | | |
| mg H2/g LAMPHY | 111.0 | 141.0 | 128.0 | 141.5 |

| elements | mg LAMPHY | mg LAMPHY |
|---|---|---|
| Na | 166.5 | 166.5 |
| K | 166.5 | 166.5 |
| NaALH4 | | |
| LiAlH4 | | |
| MgH2 | | |
| MgAl2H8 | | |
| NaBH4 | | |
| LiBH4 | 500.5 | |
| MgB2H8 | | 500.5 |
| mg H2/g LAMPHY | 219.3 | 183.0 |

The experiments are carried out according to the following protocol:
Various mixtures of Na, K and Li are produced in a mineral oil such as kerosene.
The elements were weighed and placed in a mortar in an argon atmosphere maintained between −170° C. and −78° C. on a dry ice/liquid nitrogen mixture.

The mixture is then milled with a pestle.
The milled material is then introduced into a ceramic furnace under an argon atmosphere, obtained by means of an argon flow with pumping of the fumes and vapours produced, to be heated to 100° C. to eliminate the mineral oil, then to 500° C. to produce the fusion of the metals contained in the mortar (crucible) in order to obtain a liquid metal alloy.
The alloy is brought to room temperature in an argon atmosphere. The resulting alloys, which remained in liquid form at room temperature, were weighed.
Various metal hydrides embedded in a mineral oil, such as kerosene, are placed in a mortar in an argon atmosphere maintained at between −170° C. and −78° C., then milled with a pestle.
The milled material is sieved or filtered through a 500 μm mesh sieve or filter, the filtrate or sieve is recovered and the mineral oil is evaporated in a vacuum.

The milled material is returned to an argon atmosphere and weighed.
Different proportions of liquid metal alloys and hydride milled material are then mixed under argon according to Table 1.

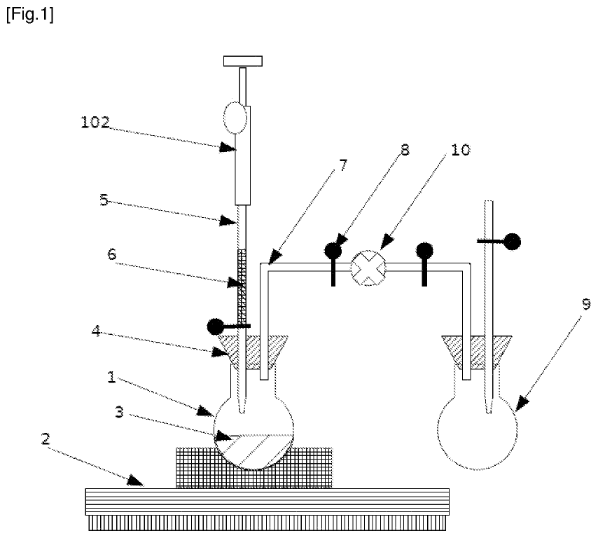

The mixtures are then pipetted into a graduated pipette FIG. 1-5 equipped with a valve 8 and a man pipette 102.

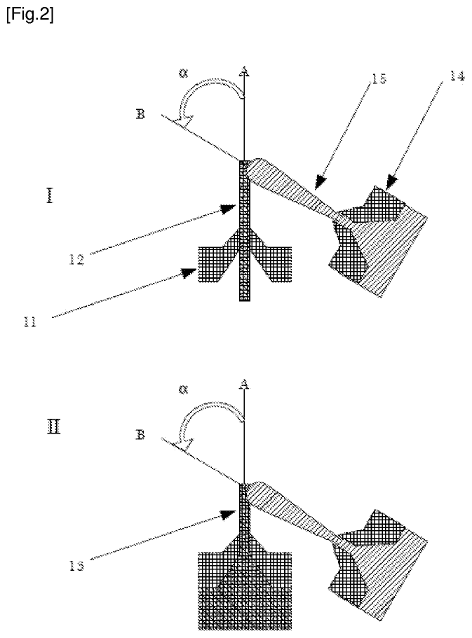

The expression “FIG. 1-5” means that we are referring to the reference 5 in FIG. 1. This manner is used in the following description to present the references of the various figures. So, in general, “FigX-Y” refers to the reference Y of the figure X.
A balloon FIG. 1-1 is placed on a balance FIG. 1-2. After the balance supporting the balloon FIG. 1-1 has been tared to 0; 0.25 g of distilled water FIG. 1-3 are introduced into the balloon FIG. 1-1, which is then plugged with a plug FIG. 1-4 allowing the graduated pipette FIG. 1-5 equipped with a valve 8, containing the LAMPHY FIG. 1-6 to be tested, to be placed on the one hand, and on the other a glass tube FIG. 1-7 equipped with a valve FIG. 1-8 which allows the vacuum to be created and the balloons FIG. 1-1 and FIG. 1-9 to be filled with argon, the balloon FIG. 1-9 being equipped with a plug 4, pipette 5 and glass tube 7 and valves 8. The glass tube 7 of the balloon FIG. 1-1 is connected to a peristatic pump FIG. 1-10 which sucks the atmosphere from the balloon FIG. 1-1 and pumps it back into the balloon 6 previously evacuated FIG. 1-9.

1 g of LAMPHY is introduced into the balloon 1 by a drop by drop system, where each drop is introduced after the previous drop has completely dissolved in the water.

Each drop of LAMPHY floats on the surface of the water with very rapid translational movements, causing shocks to the walls.

Once the drop has completely dissolved, the pump empties the atmosphere from the balloon 1 into the balloon 5.

The operation is repeated until 1 g of LAMPHY 6 is dissolved in the water contained in the balloon 1.

The contents of the balloon 1 are then evaporated and weighed once dry. The difference in weight is used to estimate the quantity of X(OH); formed. Based on the composition of the LAMPHY and the expected chemical equations presented in Chapter 5, the amount of dihydrogen produced is calculated.

The closed balloon 9 is maintained vertical perfectly still for 2 minutes between −170 and −78° C. in order to decant the heavier argon which remains at the bottom of the balloon from the lighter hydrogen which remains above the argon, in the upper part of the balloon. The plug is suddenly removed in the presence of oxygen and a flame. A characteristic detonation allows to reveal the dihydrogen formed.
8) In the experimental device implemented for the demonstration, the geometry of the admission of the LAMPHY 6 into the balloon, the impacts of the floating drops of LAMPHY on the walls of the balloon 1, and the excess of water, favour the solubilisation of the metal hydroxides X(OH)ⱼ formed and allow complete reactions, “X” being taken from Li, Na, K, Mg, Ca, Al, B, Ga etc. and “j” being between 1 and 10.

However, in a practical operating application, the LAMPHY must be implemented in a reactor that eliminates the passivation problems by forming a plate of hydroxide X(OH)ⱼ, also referred to as callus, which inhibits the reaction of the LAMPHY with the water in a stoichiometric reaction when the water is not in excess.

The inhibition of the reaction by passivation can be avoided by means of a device for mixing the water 15 and the LAMPHY 12,13 comprising two inlet nozzles allowing a dynamic mixing of the water and of the LAMPHY such that a first nozzle FIG. 2-11 introduces a filament of LAMPHY 12,13 in a direction FIG. 2-A, and a second nozzle FIG. 2-14, arranged at an angle α of between 5° and 90° to the nozzle 11, introduces in a direction FIG. 2-B a high-speed water jet FIG. 2-15, of between 0.5 m/s and 800 m/s without being exhaustive, such that the water jet 15 abrades the filament of LAMPHY leaving the nozzle 11.

The force of the water pulverizing the filament is such that the chemical reaction can take place, without a callus of X(OH); being able to form sufficiently to inhibit the reactions.

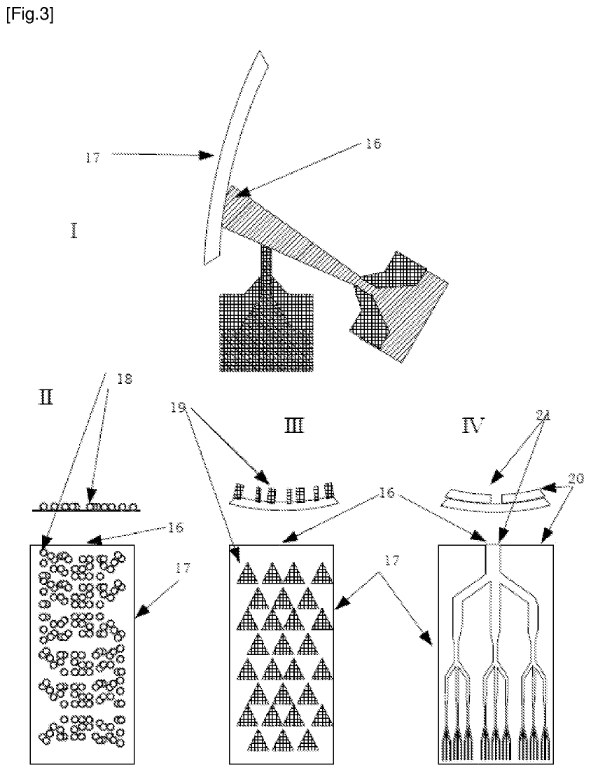

In a particular mode, the inhibition of the reaction between the LAMPHY and the water, by the formation of metal hydroxide calluses on the surface of the hydride particles, including the hydride particles formed by reaction of the metal alloy with the water, is avoided by projecting the reaction mixture, in the form of a pulverize or spray FIG. 3-16, onto a surface FIG. 3-17 capable of altering the metal hydroxide calluses formed on the surface of the hydride particles, such as an abrasive surface covered with particles FIG. 3-18 chosen from nanodiamonds, zirconia particles, zirconium particles, carbide particles, a surface comprising an array of pillars FIG. 3-19 arranged in a staggered pattern, a surface comprising a roofless array of capillaries FIG. 3-20, and any combination of these surfaces and these components.

In a preferred embodiment, the nozzle 11 dispensing the LAMPHY filament will be arranged at the inlet 21 of a roofless capillary array 20, such that the outlet of the nozzle 11 is in a plane that is more or less tangential, or even parallel, to the inlet 21 of the capillaries, so that the advance of the filament pushes the LAMPHY filament (extruded or solid) above the inlet, or into the inlet of the roofless capillary array. The nozzle 14 of the water jet is then arranged above the entrance to the capillary array at an angle such that the jet pulverize the LAMPHY, pushing the solution and/or suspension, and the particles obtained after pulverization, into the capillary array, causing the whole to migrate within the roofless capillary array, thus allowing the various components of the pulverize to react with each other during their passage through the capillary array while accelerating the products in the capillary array under the action of the gases emitted.

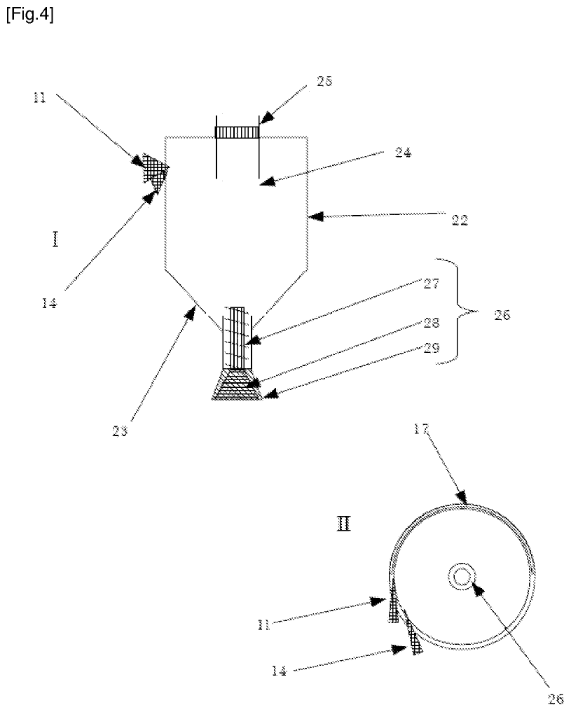

The device can be augmented by arrays of capillaries with several inlets, preferably parallel to each other, opposite which are arranged nozzles producing jets of pressurised water and LAMPHY filaments at suitable angles.
9) The nozzle devices 11, 14 and possibly the abrasive surfaces 17 and/or the capillary arrays 20 may be implemented in a cyclone FIG. 4-22, such that the nozzles FIG. 4-11, FIG. 4-14 are arranged tangentially to the inner wall of the cyclone in its top part, such that the pulverize spray of the LAMPHY filament by the jet of water and the gas resulting from the meeting of the water and the LAMPHY is emitted tangentially to the wall of the cyclone so as to create a downward swirling movement in the cyclone thus forming a vortex.

The solutions formed and the gases swirl to the lower cone of the cyclone FIG. 4-23, the convection movements caused by the cone 23 then form an upward column of gases, while the heavier bodies, the solutions and particles, accumulate in the cone 23.
10) a central collector tube at the top FIG. 4-24 and in the centre of the cyclone allows to capture the gases rising to the centre of the cyclone.

In some embodiments, a filter FIG. 4-25 will be placed in or around the collector tube 24 so as to allow only the gases to pass through.

In an even more specific embodiment, the filter 25 will be permeable only to the dihydrogen, in other embodiments the filter will be permeable only to the hydrogen ions H⁺ or to a combination H⁺/H₂
11) At the bottom of the cone of the cyclone, there is an outlet mechanism FIG. 4-26 for the material accumulated in the cone. The output mechanism will comprise, for example, an endless screw FIG. 4-27, preferably a variable pitch endless screw, larger at the beginning and smaller at the end of the endless screw so as to compress the materials between the beginning and the end of the screw. As a result, the gases contained in the materials will tend to be expelled as they pass through the screw thread.

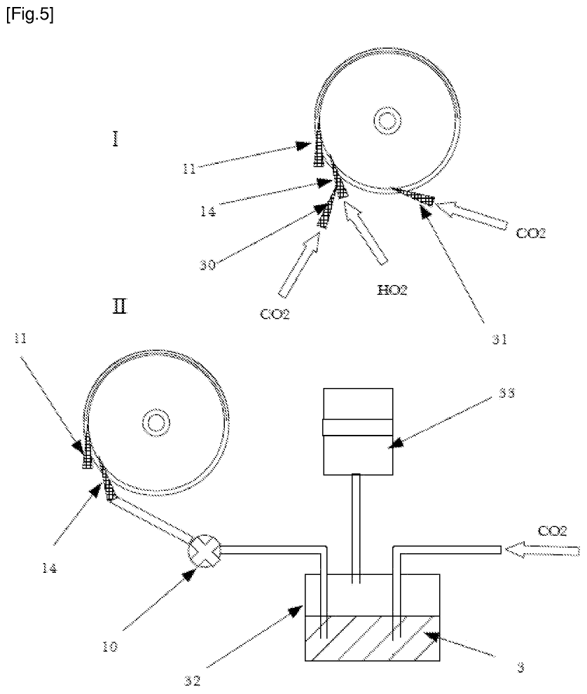

The endless screw will continue, for example, with the hub of a mill FIG. 4-28, arranged in the centre of a milling cone FIG. 4-29 comprising milling grooves. The mill allows to crush any particles that may have formed or not dissolved, thus completing the reaction of the LAMPHY with the water.
12) The reactions can be shifted to become complete by injecting an acid either directly into the cyclone via a tangential inlet to the wall of the cyclone FIG. 5-31, at the top of the cyclone, or by dissolving said acid in the water FIG. 5-30 before it passes through the nozzle 14.

In a particular embodiment, the acid chosen will be CO₂, either injected directly into the cyclone or dissolved in the water circulating in the nozzle 14 in the form of di-hydrogen carbonate H₂CO₃ or hydrogen carbonate HCO₃⁻ FIG. 5-32.

In some embodiments, hydrogen carbonates may be injected in the form X^{j+} (HCO₃⁻)ⱼ, such that “X” is taken from n⁺, d²⁺E³⁺ and “j” is between 1 and 10.

These acids will neutralise the hydroxy ions produced, such as

X(OH)ⱼ+j(H₂CO₃)→X(HCO3)ⱼ+jH₂O

or

X(OH)ⱼ+jn(HCO₃⁻)→Xn(CO₃)ⱼ+jH2O

These reactions can be used as a support to sequester CO₂ in the form of a bicarbonate or carbonate stabilised by an n⁺, d²⁺, E³⁺ cation. The carbonate anions and their counterions can be isolated dry in crystalline form by evaporating the brines obtained.
13) In some embodiments, particles of bicarbonate and metal ion, X(HCO³)ⱼ or optionally metal ion carbonate, Xn(CO3)ⱼ will be added to the pulverized water to act as an abrasive on the LAMPHY filament.
14) In some embodiments, abrasive elements 17 will be deposited on the internal wall of the cyclone or of the capillary array 20, so that the particles contained in the LAMPHY rubbing against the wall of the cyclone by the action of the vortex are abraded by said abrasive elements and the metal hydroxide callus covering these particles is eliminated, leaving the metal or the hydride accessible to the action of the water to produce dihydrogen.

In a particular embodiment, the abrasive elements 18 may be nanodiamond particles with a size of between 4 nm and 500 nm.

These could also be zirconium particles between 4 nm and 500 μm or silicon carbide particles between 4 nm and 500 μm, and more generally any kind of abrasive elements.
15) In a particular embodiment, a pillar mixer 19 can be introduced on the internal wall of the Cyclone to complement or replace the capillary array 20. The mixer will consist of a array of pillars, preferably with a triangular, square or round cross-section, arranged in a staggered pattern and spaced from each other by 500 μm to 100 nm.

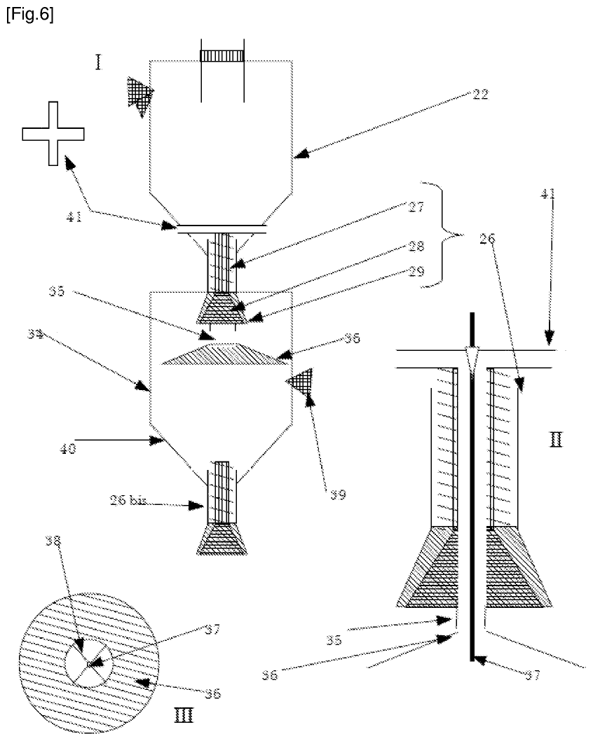

When the pulverized LAMPHY/H2O mixture is projected onto the internal wall of the cyclone, the array of pillars of the mixer arranged on the internal wall of the cyclone will form obstacles to the linear passage of the LAMPHI/H₂O mixture, causing shocks and turbulence which destabilise the hydroxide calluses and promote the reaction of the water on LAMPHY.
16) In a particular embodiment, a second cyclone FIG. 6-34 is arranged after the first cyclone 22 such that the extraction device 26 of the first cyclone is at the top of the second cyclone.

In this embodiment, the centre of the hub FIG. 6-28 and of the endless screw FIG. 6-29 are hollow and form the collection cylinder FIG. 6-35 of the second cyclone 34.

The material from the first cyclone will be conveyed into the second cyclone by the endless screw 27 and the mill 28, such that the material falls into the second cyclone, onto a conical form FIG. 6-36 disposed after the mill 28 and such that said material is centrifugally dispersed in the second cyclone as the conical form rotates. Said conical shape 36 is attached to the axis 37 passing through the hub of the mill 27 and the endless screw 28 by an attachment cross 38. As it rotates, the shaft 37, which is secured to these three elements, drives the endless screw 27, the hub of the mill 28 and the conical shape 36.

A tangential inlet of CO₂ FIG. 6-39 arranged through the wall of the second cyclone, below the conical shape 36, allows the addition of CO₂ into the second cyclone, such that the CO₂ introduced entrains in a vortex the materials, including H₂O, X(OH); optionally X(HCO₃)ⱼ, coming from the first cyclone and dispersed by the conical shape. The vortex will carry the material to the lower cone FIG. 6-40 of the second cyclone, where convection movements will cause the gases to rise in a column of rising gases; said gases will be captured by the collection cylinder 35 formed by the centre of the endless screw and of the hub of the mill of the first cyclone.

The heavier materials, such as water, metal hydroxides, carbonates, hydrogen and dihydrogen, accumulated in the lower cone of the second cyclone, can be pressed and evacuated by an extraction device 26 Bis.

In addition to the reactions described, reactions such as

CO₂+X(OH)ⱼ→X(CO₃H)ⱼ
may take place to a greater or lesser extent.
17) The gases rising in the central gas column of the second cyclone, consisting essentially of CO₂ which will not have react, any dihydrogen and water vapour, will be captured by a capture structure FIG. 6-41 above the endless screw 27 and connected to the collection cylinder 35. The capture structure 41 will allow the rising gases to be conducted to the outside of the cyclone.
18) The capture structure 41 will be connected to a bubbling tank 32 fed with water. In a particular embodiment, the water from the bubbling tank will be used to feed the nozzle 14.
19) LAMPHY has variable properties depending on its composition and can, in certain cases, behave like a non-Newtonian fluid, particularly for particle contents exceeding 30% of the mass, nevertheless, the extrusion of the LAMPHY filament must be finely controlled.

On the other hand, the reactivity of the LAMPHY to oxygen requires a packaging that offers a good isolation from oxygen and water.

Different models of pump or press can be used to feed the nozzle 11.

But in a particular application, the LAMPHY will be packaged in a tube 42 made of metal, steel, aluminium, composite or plastic such as PVC or polyurethane, polycarbonate etc. or any other material offering a good sealing against oxygen and inert for LAMPHY.

The tube will have a diameter of between 1 cm and 20 cm, for example, and a length of between 1 cm and 100 cm.

One end of the tube will be conical in shape with a valve 43 at its summit so that when the valve is screwed in, it is pushed back allowing the valve to open and when the valve is screwed out, the valve is closed again.

The other end of the tube will be closed by a movable piston 44, whose internal face of the tube will be cone-shaped to complement the conical end of the tube.

LAMPHY will be stored in the tube between the valve and the piston.

The piston 44 can be equipped with a joint 45 for the sealing, or alternatively the internal face of the tube can be made of a material that is deformable when the piston passes through, to guarantee a perfect sealing.

In some embodiments, the piston is made of a material that is sufficiently flexible for its deformation to guarantee a sealing.

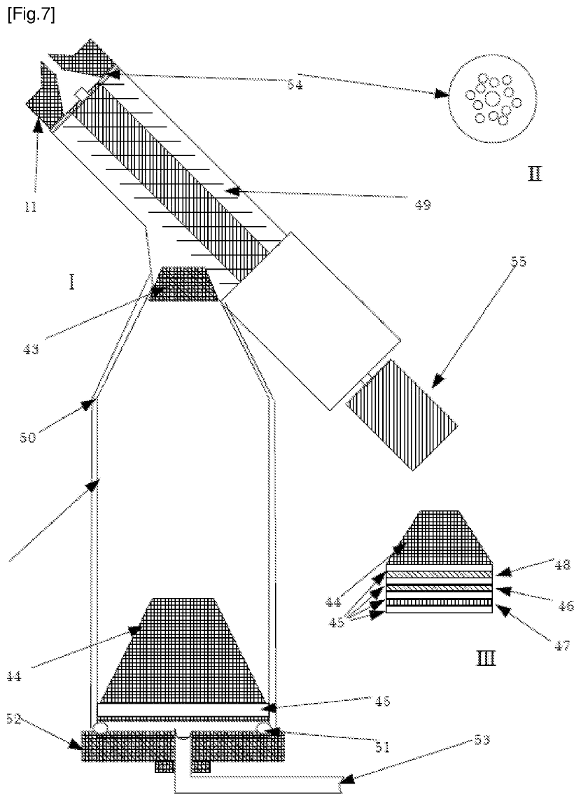

In some embodiments, the piston will have a housing FIG. 7-46 filled with a Fluorocarbon liquid, which is both hydrophobic and lipophobic in order to guarantee the perfect sealing of the system. The compartment may be doubled at the rear FIG. 7-47 by another compartment containing a mineral lubricating oil and upstream by a tank FIG. 7-48 filled with a mineral storage oil such as kerosene.
29) The valve 43 is connected with the conduit of an endless screw pusher 49 and the tube 42 and included in a container 50 obstructed at the end by a joint 51 and a plug 52 isolating the end of the tube, such that by applying a pressure with a gas through the tube 53 and the plug 52, the movable piston 44 displaces and reflects the pressure on LAMPHY contained in the tube, so that the endless screw 49 at the other end is always in contact with LAMPHY.

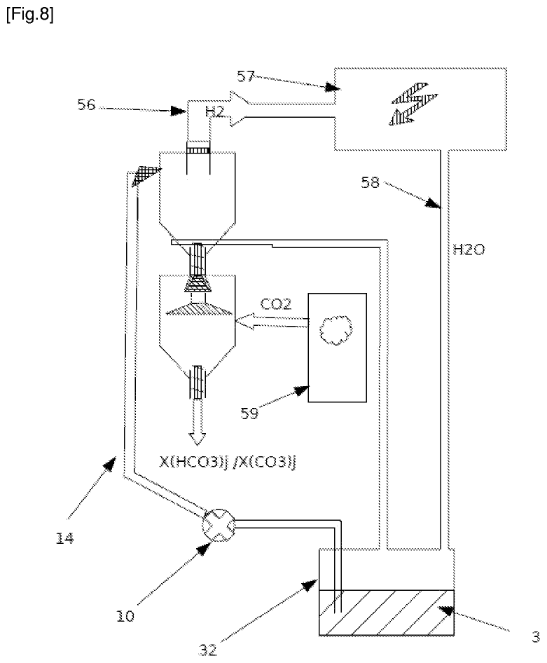

The endless screw have a thread preferably greater than 45° to prevent a flowing under the sole action of the pressure, without the endless screw 49 being in motion. Only the movement of the endless screw can move the LAMPHY forward in the Nozzle 11 through the grid 54 located at the end of the endless screw. The motion of the screw is preferably ensured by a stepping motor 55 or a brushless motor. The gas used to pressurise the piston is preferably argon or CO₂.
30) In a preferred embodiment, the dihydrogen produced FIG. 8-56 will feed a hydrogen fuel or fuel cell FIG. 8-57 and the water produced FIG. 8-58 by the hydrogen fuel cell will feed the bubbling tank FIG. 8-32.
31) In certain embodiments, the CO₂ used will be produced by a combustion engine FIG. 8-59, a boiler or a burner, such that the exhaust or the chimney is introduced tangentially into the second cyclone of the reactor and is used as a source of CO₂ production.

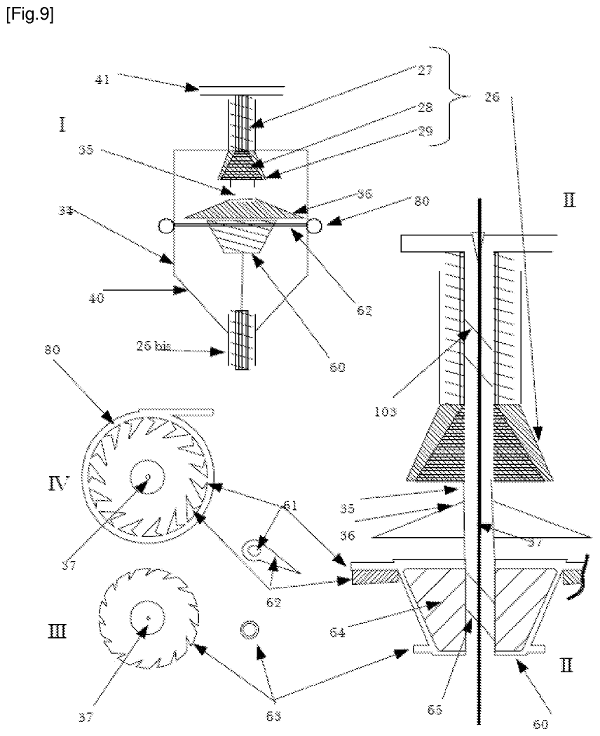

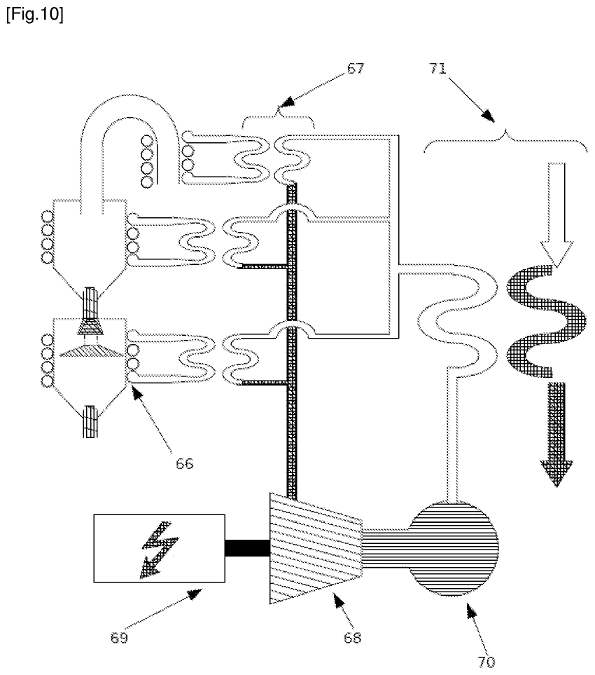

In this configuration, the CO₂ produced will be stored in the form of hydrogen carbonate or carbonate and cation.
32) In a particular embodiment, CO₂ is injected into the second cyclone of the reactor after passing through the turbine of a turbocharger.
34) In a particular embodiment, the turbine FIG. 9-60 of a turbocharger of an internal combustion engine is integrated into the second cyclone 34 of the reactor, such that an axis FIG. 9-37 is introduced into the centre of the cyclone, the axis being secured to the axis of the turbine and the axis of the extractors 26 possibly coinciding with the axis of the rising gas collector. A protection and diffusion cone 36 is inserted on the axis FIG. 9-37 between the turbine 60 and the extractor 26. The turbine can be fed via a tube tangential to the skirt FIG. 9-60 of the turbine, but preferably via a plurality of tubes 61 whose profile forms a system of vanes or fins 62 orienting the orientation of a vortex, with the materials and possibly the gases entering the second cyclone via the extractor 26. At the turbine outlet, a system of tuyeres 63 directs the outlet of the gases of the turbine into a rotation in the same orientation as the orientation of the vortex induced by the vane system 62. The turbine will have a wheel or rotor with two levels of vanes, outer vanes 64, directed in one orientation, which will be driven by the gases entering the turbine through hoses 61. At the centre of the wheel, a second set of vanes 65, possibly reversed with respect to the first set of vanes 64, interacts with the central flow rising at the centre of the cyclone and causing the wheel to rotate in the same orientation as the outer vanes 64. The second set of vanes may be shrouded by a contiguous tube and fitted into the collector 35. The shaft 37 can be extended outside the reactor to be coupled with an electric turbine or a pump.
35) In a particular embodiment, the axis 37 is extended into the central collector of the first cyclone 24. In the central collector of the first cyclone, the shaft will comprise a series of vanes allowing it to be driven by the gases rising in the central tube of the first cyclone.
37) In certain embodiments, an exchanger comprising a system of interconnected pipes FIG. 10-66 is introduced into the wall of each cyclone allowing the cyclones to be cooled, such that a heat transfer fluid selected, without being exhaustive, from liquid alkali metal alloys selected from Li, Na, Ka, perfluorocarbon-based fluids with a boiling point above 100° C., or distilled water or any other existing heat transfer fluid circulates in the exchanger.

In some embodiments, the heat transfer fluid will be a LOCH in its hydrogenated form, so that the thermal energy captured in the reactor wall activates the dehydrogenation reaction of the LOCH, thereby releasing the dihydrogen.
38) The cooling circuit of the reactor will be coupled via the exchangers FIG. 10-67 to an ORC (Organic Rankine Cycle) circuit comprising at least one preferably perfluorinated heat transfer fluid, with a condensation/boiling point of between 20 and 150° C., at least one turbine FIG. 10-68 possibly coupled to a generator 69, at least one expansion vessel FIG. 10-70 and at least one air/water or air/air exchanger FIG. 10-71 for example in the form of a radiator.
39) It should be noted that the reaction of the metal hydrides with water is very exothermic, with enthalpies of the order of or less than −180 kJ/mol, of the same order of magnitude as or greater than the energy provided by the reaction of the dihydrogen with the oxygen. The thermal cycle for cooling the reactor allows to provide a significant additional energy by recovering this energy in an ORC.
40) In some embodiments, the central axle 37 of the reactor is coupled to an electric motor allowing to rotate this axle.
41) In a certain embodiment, LAMPHY will have a consistency allowing a stable shaping, in the form of a filament or yarn, in a durable and storable manner. For example, in the form of a spool of wound yarn with a diameter of between 500 μm and 5 mm.

In some embodiments, the yarn is passivated to a depth of 20 nm with a metal hydroxide, alternatively with alumina.

In a particular embodiment, the yarn will be contained in a container filled with kerosene or another mineral or organic oil. In this embodiment, the container allows the filament to be unwound without rubbing, the spool of yarn being mounted on its axle on two ball bearings, ball rollings or two magnetically levitated bearings.

In a particular embodiment, the organic liquid for storing the filament will be a hydrogen-carrying organic liquid or LOCH, in its hydrogenated form, such that the liquid is emitted at the same time as the filament into the cyclonic reactor, the reaction of the LAMPHY with the water providing the energy necessary for the dehydrogenation of the hydrogenated LOCH molecule, thus increasing the dihydrogen efficiency.

In some embodiments, a spray of LOCH is injected into the cyclonic reactor at the same time as the LAMPHY so that the exothermic energy of the reaction between LAMPHY and the water allows the release of the hydrogen from the LOCH molecules.

In this embodiment, the yarn exits the container through an orifice equipped with a lip joint, or any other joint capable of maintaining the kerosene in the container as the yarn exits.

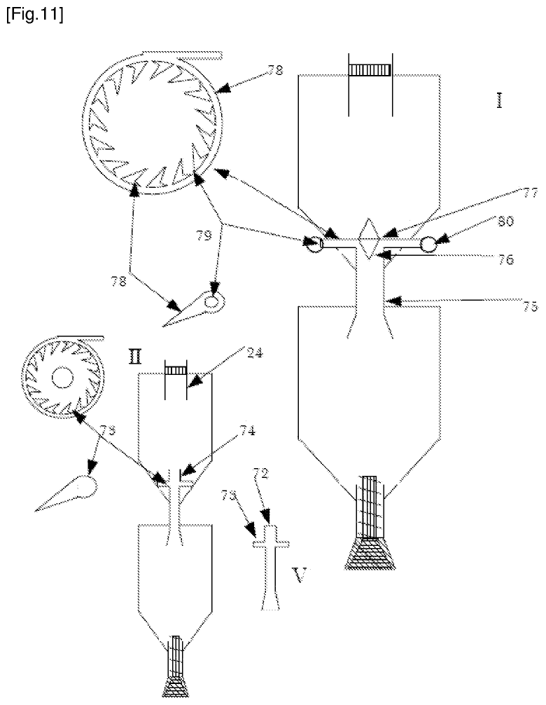

In some embodiments, a movable piston capsule filled with argon or CO₂, kerosene or LOCH compensates for the volume lost in the container as a result of the yarn leaving the container. The capsule will take the form, for example, of a piston accumulator, one of whose chambers may be left at ambient pressure equilibrium
42) In a particular embodiment, a filament already shaped and stored on a spool is introduced into the nozzle 11 by means of a system of rotating rollers, such that the roller or rollers pinching the filament is/are included in a lodge filled with kerosene or another mineral oil inert to LAMPHY, with an inlet of the filament closed by a lip joint and an outlet of the filament closed by another lip joint through which the filament passes. A second lodge, adjacent to the first, filled with fluorocarbon and closed by a lip joint through which the filament passes, may be positioned just in front of the nozzle 11,
43) In a particular embodiment, the material outlet mechanism 26 arranged in the outlet cone of the cyclone will be replaced by a device comprising a central cylinder or a cone FIG. 11-72 surrounded by a set of vanes 73 inclined in the orientation of rotation of the vortex such that the gases of the vortex passing over said vanes are not thwarted in their convection movement to form the central rising gases column.
44) In certain embodiments, the cylinder or cone 72 of the upper cyclone is replaced by a tube fused 74 with the collector of the inner cyclone, so that the gases rising from the gas column of the lower cyclone rise in the upper cyclone and merge with the gas column rising from the upper cyclone such that the assembled or fused columns are captured by the collector FIG. 11-24 of the upper cyclone.

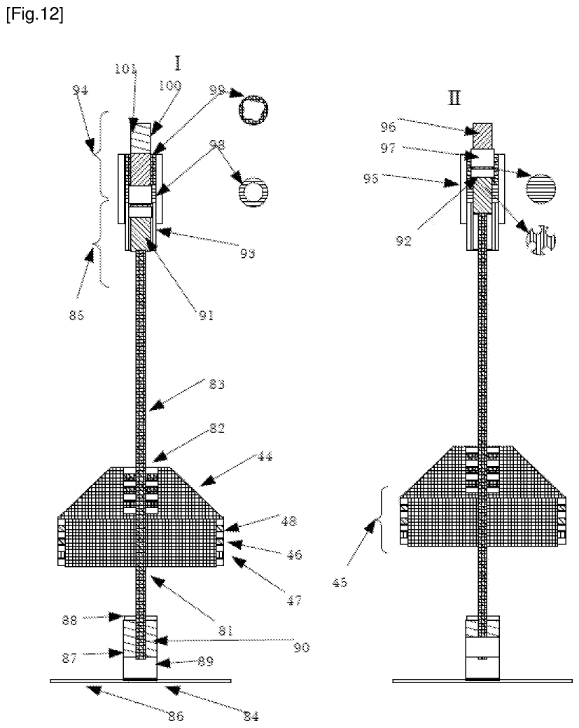

“Assembled” refers to the juxtaposition of streamlines and “mixing” refers to the mixing of gases.
45) In other embodiments, the collector tube 75 will be closed at its top end, for example, by an inverted conical shape 76, and for example capped by a cone-shaped cap 77. The vanes 78 arranged around the tube 75 will be hollow 79 and open at one of their ends into the lumen of the tube 75 and at the other of their ends into an annular tank FIG. 11-80 so that the gases rising from the cyclone are captured by the tube 75 and conducted through the vanes to an annular tank FIG. 11-80 and to the outside of the cyclone.
46) In a particular embodiment, the LAMPHY is stored in a tank having a valve opened by the action of a pressure. The tank may comprise a piston FIG. 12-44 of conical shape having on its outer surface a sealing system FIG. 7-45 FIG. 12-45. The piston FIG. 12-44 is pierced by a central hole FIG. 12-81. The hole will have a system of joints FIG. 12-82, for example of the same nature as the outer joints 45, such as the joints 82 ensuring a sealing with an axle FIG. 12-83 passing through the piston FIG. 12-44, by connecting a tensioning mechanism FIG. 12-84, at one end of the container, to the opening mechanism of the valve FIG. 12-85. The tensioning mechanism comprises a bar FIG. 12-86 secured to a cylinder FIG. 12-87, said cylinder being closed by a washer 88 pierced with a hole through which the axle 83 passes. The travel of the axle 83 is limited by a piston 89, secured to the shaft 83 arranged in the cylinder 87, the translational movement of the shaft 83/piston 89 assembly is constrained by a spring FIG. 12-90. The valve itself 85 comprises a piston FIG. 12-91 comprising a round part and a splined part, the piston 91 is arranged at the summit of the axle 83, said piston being equipped with a sealing joint 92. The piston 91 is enclosed in a cylinder 93. The complement of the valve FIG. 12-94, for example, a device for receiving the valve comprising, a receiving cylinder 95, in which the cylinder 93 can be attached, for example screwed or embedded; a piston 96 equipped with a joint 97 and sliding in a cylinder comprising two parts, a perfectly adjusted part 98, preventing leakage between the cylinder and the piston 96-97, and a part 99 comprising regular channels allowing the passage of the LAMPHY between the piston 96-97 and the cylinder 99. The piston 96 is inserted into a cylinder 100 containing a spring 101 capable of pushing back said piston 96.

When the valve itself 85 is positioned in its reception 94, the piston 91, under the action of the spring 90, keeps the valve closed. Similarly, the piston 96, under the action of the spring 101, keeps the other part of the valve closed. When a pressure is applied to the piston 44, the pressure is transmitted to the LAMPHY contained in the container by the movement of the piston 44. The LAMPHY then presses on the piston 91, compressing the spring 90. The piston 91 in turn presses on the piston 96 causing it to retract into the cylinder 100, compressing the spring 1001. The LAMPHY can then flow through the cannulas in the part of the cylinder 99 and of the piston 91. When the pressure at the level of the piston 44 stops, the springs 90 and 101 relax, returning the pistons 91 and 96 to the closed position without letting any product out. This device allows the containers to be placed without the LAMPHY being able to escape.

### LEGENDS FOR THE ASSEMBLY OF THE FIGURES

1) Balloon
2) balance
3) distilled water
4) plug with two holes
5) graduated pipette
6) LAMPHY
7) glass tube
8) valve
9) Balloon
10) pump
11) Nozzle for LAMPHY
12) LAMPHY filament preformed from a LAMPHY
13) LAMPHY filament formed from an amorphous or liquid LAMPHY
14) nozzle for water
15) high-speed water jet
16) Impact of a pulverize or a spray of the LAMPHY reaction mixture and water
17) surface capable of altering a metal hydroxide callus
18) abrasive particle
19) roofless capillary array
20) hollow anode preferably forming a perforated inverted cone
21) the entrance to the roofless capillary array
22) Cyclone, cyclonic reactor for the reaction of LAMPHY and water
23) lower cone of the cyclone
24) central collector tube of the cyclone
25) Particle and/or H2 and or H+ discriminating filter
26) bottom outlet mechanism of the cyclone
27) endless screw
28) central hub of a mill comprising, for example, grooves
29) milling cone of a mill comprising, for example, grooves
30) injection of CO₂ into the nozzle 14
31) injection of CO₂ through a nozzle in the cyclone
32) CO₂ feeding bubbler
33) Pressure accumulator
34) reception cyclone of the Hydroxides
35) the cyclone reception collection cylinder for the hydroxides
36) Rotating conical shape
37) central axis of the reactor
38) Axle attaching cross
39) tangential inflow of CO₂
40) lower cone of the second reception cyclone of the Hydroxides
41) capture structure that conducts the gases rising outside the cyclone.
42) conditioning tube of the LAMPHY
43) Valve for LAMPHY
44) LAMPHY container mobile piston
45) sealing joint
46) housing filled with a Fluorocarbon liquid
47) housing filled with a mineral lubricating oil
48) housing filled with a mineral storage oil.
49) endless screw pusher 49
50) container tube 42
51) a joint 51 and a plug 52
52) container plug 50
53) Pressure application tube with a gas through the plug
54) grid located at the end of the endless screw
55) stepping motor ensuring the motion of the endless screw
56) hydrogen produced
57) hydrogen fuel cell
58) water produced FIG. 8-58 by the hydrogen fuel cell
59) combustion engine
60) Skirt of a turbine for a turbocharger of an internal combustion engine
61) profiled tube for feeding gas to a turbine (60)
62) tube profiled 60 forming a system of vanes or fins
63) tuyere 63 directing the outlet of the gases of a turbine
64) outer vanes of a wheel or rotor with two levels of vanes
65) inner vanes of a wheel or rotor with two levels of vanes
66) exchanger comprising a pipe system introduced into the wall of the cyclone
67) exchanger with an ORC circuit coupled to the cooling circuit of the reactor
68) turbine coupled to a generator
69) generator
70) expansion vessel
71) air/water or air/air heat exchangers
72) central cylinder or a cone surrounded by a set of vanes
73) set of vanes inclined in the orientation of rotation of the vortex
74) tube 72 fused with the collector of the inner cyclone.
75) collector tube closed at its top end,
76) inverted cone shape closing the collector tube 75
77) cone-shaped cap of the collector tube 75.
78) hollow vanes arranged
79) open vane conduit
80) annular tank equipped with a outlet conduit
81) central hole of the piston 44
82) joint of the hole ensuring the sealing with the axle 83
83) axle passing through the piston 44,
84) tensioning mechanism for the axle 44
85) opening mechanism proper of the valve.
86) a tension bar
87) cylinder secured to the bar 86 closed by a washer 88
88) closing washer of the cylinder 88 and pierced with a hole,
89) piston secured to the axle 83, in the cylinder 87
90) stress spring of the cylinder 87
91) piston of the valve 85 and comprising a round part and a splined part,
92) sealed joint 91
93) inclusion cylinder of the piston 91
94) The complement of the valve 85: device designed to receive 85
95) reception cylinder
96) piston 96 sliding in a cylinder 98-99
97) sealed joint 97
98) adjusted part of the cylinder 98-99
99) part 99 comprising regular channels in the cylinder 98-99
100) insertion cylinder of the piston 96 101 capable of pushing said piston back.
101) Spring pushing back the piston 96
102) Manual man pipette
103) propeller arranged on axle at the level of the collector

1. A dihydrogen storage system, comprising a suspension of hydride particles with an average diameter of between 1 nm and 800 μm, in an alloy of at least two alkali metals chosen from Na (sodium), K (potassium) and Li (lithium).

2. The dihydrogen storage system according to claim 1, wherein said alloy contains at most 98% by mass of a single alkali metal, and said hydride particles have a diameter of between 50 nm and 50 μm, selected from Li H, Na H, K H, Ca H₂, Mg H₂, BeH₂, Al H₃, InH₃, TIH₃, GaH₃, BH₃, Al H₄⁻, InH₄⁻, TIH₄⁻, GaH₄⁻, BH₄⁻, TiH₂, and ZnH₂.

3. The system according to claim 1 wherein the proportion by mass of the alkali metal alloy with respect to the suspension of hydride particles is between 3 and 97% of the total mass of the system.

4. The system according to claim 1, wherein the alkali metal alloy is supplemented, up to 50% of its mass, by any combination of Be, Mg, Ca Al, Ga, P, In and TI.

5. A method for storing dihydrogen in a dihydrogen storage system according to claim 1, comprising a step of preparing an alloy of at least two alkali metals chosen from Na (sodium), K (potassium) and Li (lithium), a step of preparing a plurality of hydride particles, and a step of mixing the alloy and the particles in order to obtain a suspension of the particles in said alloy and the formation of said dihydrogen storage system.

6. A method for producing dihydrogen from a dihydrogen storage system according to claim 1, comprising a step of reacting the system with H₂O.

7. The method according to claim 6, wherein the system is in the form of a filament and is pulverized by a high-velocity water jet of between 0.5 m/s and 800 m/s.

8. The method according to claim 7, wherein the filamentary system is produced by an extrusion simultaneously with the reaction with the water or prior to this reaction.

9. The method according to claim 6, comprising a step of activating the reaction between the system and the water, using an acid, preferably carbonic acid CO2, optionally in one of its hydrogen carbonate and di-hydrogen carbonate forms.

10. The method according to claim 6, comprising a step in which the reaction of a metal hydroxide with the CO₂ produced by an internal combustion engine, a boiler or a burner allows to sequester said CO₂ produced, in another hydrogen carbonate or carbonate form.

11. The method according to claim 6, wherein the inhibition of the reaction between the system and the water is lifted by a surface capable of altering a hydroxide callus formed on the surface of hydride particles, when a system/water reaction mixture is projected onto said surface, said surface being, for example, an abrasive surface chosen from the surfaces covered with nanodiamonds, zirconia particles, carbide particles, a surface comprising an array of staggered pillars, a surface comprising an array of roofless capillaries, and any combination of these surfaces.

12. A device for implementing a method according to claim 6, comprising a cyclone-type reactor for the reaction between H₂O and the system, this reactor comprising at least one cyclonic structure which allows the formation of a vortex, and a column of gas and vapour rising to the centre of the reactor, and having, in the low position, a device for extracting the heaviest materials, solids and liquids, and, in the top part, a central collector for the vapours and gases.

13. The device according to claim 12, wherein said extraction device comprises any combination of an endless screw, a central hub mill, a hollow endless screw, alternatively any combination of a tube and vanes which are optionally hollow.

14. The device according to claim 12 wherein said reactor of the cyclone type comprises, in its wall, an exchanger comprising a system of interconnected pipes, and capable of circulating a heat-transfer fluid selected, without being exhaustive, from the liquid alkali metal alloys comprising Li, Na, K, perfluorocarbon-based fluids, distilled water, existing heat-transfer fluid, and such that, in a preferred implementation, the system of pipes of the exchanger of the cyclone is in contact with a second exchanger of an ORC (Organic Rankine Cycle) circuit.

15. The device according to claim 12, comprising, a hydrogen fuel cell, a bubbling tank and a nozzle, and in that the dihydrogen produced by the cyclone-type reactor feeds the hydrogen fuel cell, the water produced by the consumption of dihydrogen by the hydrogen fuel cell feeding the bubbling tank, and the bubbling tank feeding the nozzle.
